(19) United States
(12) Patent Application Publication
(10) Pub. No.: US 2008/0278978 A1
(43) Pub. Date: Nov. 13, 2008

(54) HIGH VOLTAGE INDUCTIVE CHARGE PUMP DC-TO-DC CONVERTER ASSEMBLY

(75) Inventor: Perry R. Czimmek, Williamsburg, VA (US)

Correspondence Address: CARLSON, GASKEY & OLDS, P.C., 400 WEST MAPLE ROAD, SUITE 350, BIRMINGHAM, MI, 48009, US

(73) Assignee: SIEMENS VDO AUTOMOTIVE CORPORATION, Auburn Hills, MI (US)

(21) Appl. No.: 11/745,563

(22) Filed: May 8, 2007

(51) Int. Cl. H02M 3/18; H02J 7/00

(52) U.S. Cl. 363/60; 320/166; 363/59

(57) ABSTRACT

A method and apparatus for a power converter assembly charges a first capacitor and a second capacitor in parallel to a first voltage and at a first polarity, and then discharges the first capacitor and second capacitor in series at an output voltage that is greater than the input voltage and at a second polarity that is opposite the first polarity. This “charge pump” process is repeated and filtered to produce a continuous output.

### BACKGROUND OF THE INVENTION

This application relates generally to electronic power systems and, more particularly, to charge pump DC-to-DC converter assemblies.

A power supply is integrated into nearly every electronic device, both consumer and industrial, including vehicle ignition electronics, portable electronic equipment, integrated in-vehicle systems, computers, medical instrumentation, and many other devices. Within an electronic device, it may be necessary to either increase or decrease a voltage by using either a step-up or a step-down power converter. A step-up converter can be used to increase voltage, and a step-down converter can be used to decrease voltage.

In the realm of step-down converter technology, there are many varied and efficient solutions at nearly every power level. However, many step-up converters, particularly ones used in high power applications, utilize heavy AC transformers or large, high-voltage chokes which can increase the size, weight, and cost of a converter assembly. There is a need for a low-cost and easily implemented solution for a step-up converter assembly that is capable of handling high power applications.

### SUMMARY OF THE INVENTION

A power converter assembly converts a low voltage direct current to a high voltage direct current. The converter comprises a first capacitor and a second capacitor, wherein the first capacitor and the second capacitor are operable to be charged in parallel to a first DC voltage and at a first polarity, and to discharge in series at a second DC voltage that is greater than the first DC voltage and at a second polarity which is opposite the first polarity. A switch is coupled to the first capacitor and is operable to control the discharge of the first capacitor and the second capacitor.

These and other features of the present invention can be best understood from the following specification and drawings, the following of which is a brief description.

### BRIEF DESCRIPTION OF THE DRAWINGS

FIG. 1a illustrates a single stage of a power converter assembly according to a first embodiment of the present invention, charged at a first polarity.

FIG. 1b illustrates the assembly of FIG. 1a charged at a second polarity opposite the first polarity.

FIG. 2a illustrates a single stage of a power converter assembly according to a second embodiment of the present invention, charged at a first polarity.

FIG. 2b illustrates the assembly of FIG. 2a charged at a second polarity opposite the first polarity.

FIG. 3 illustrates the assembly of FIG. 1a cascaded to form a three stage converter assembly with a single output.

FIG. 4 illustrates the assembly of FIG. 2 cascaded to form a three stage converter assembly with multiple outputs.

FIG. 5 illustrates a voltage across an inductive winding of a converter assembly as a function of time.

FIG. 6 illustrates a rise time of a voltage at an output of a converter assembly as a function of time.

FIG. 7 illustrates a voltage across an inductive winding with a smaller inductance than the winding of FIG. 5 as a function of time.

FIG. 8 illustrates a voltage at an output of a converter assembly as a function of time.

### DETAILED DESCRIPTION OF THE PREFERRED EMBODIMENT

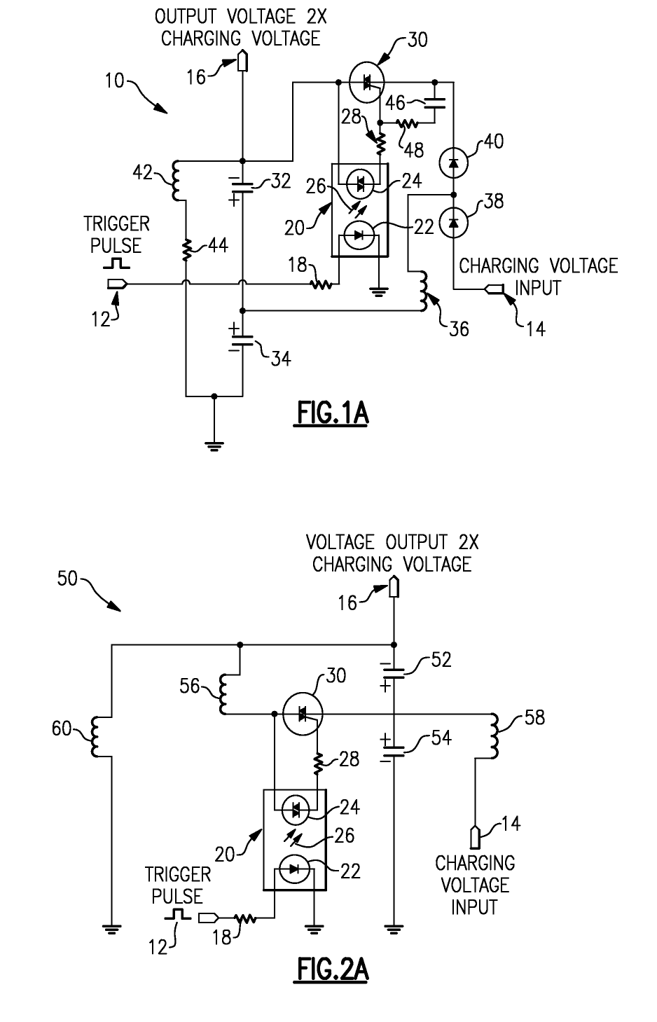

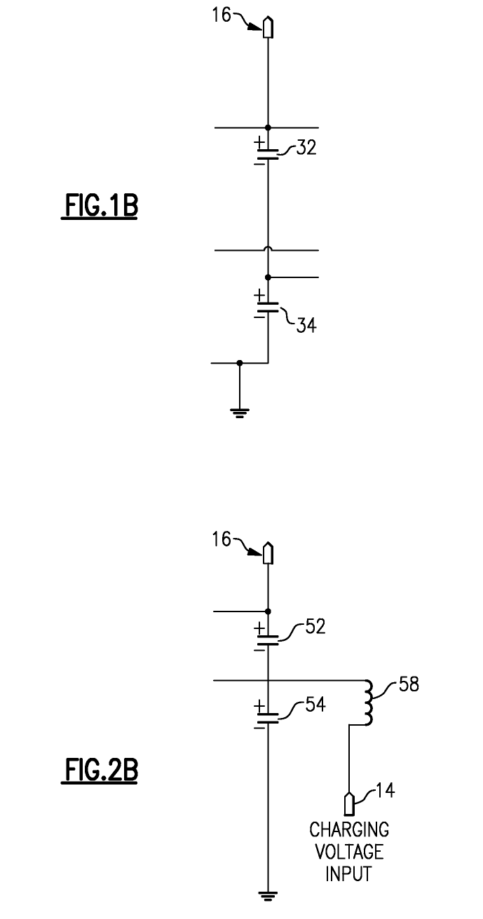

FIG. 1a illustrates a single stage of a power converter assembly 10. The assembly 10 has an input pulse 12 and a charging input voltage 14. The converter increases the input voltage 14 to an output voltage 16 by a factor of 2×N, as represented by the equation:

Vₒᵤₜ=Vᵢₙ×2×N equation #1

where “Vₒᵤₜ” is the output voltage 16;

“Vᵢₙ” is the input voltage 14; and

“N” is the number of stages.

FIG. 1a illustrates a single stage where N=1.

The input pulse 12 provides electric current that passes through a current-limiting resistor 18 to an optocoupler 20. The optocoupler 20 comprises a light-emitting diode (LED) 22 and a diode for alternating current (DIAC) 24 that are electrically isolated. Electrical isolation is important in a high-voltage application where the output voltage 16 is significantly greater than the input pulse 12. However, when not operating in a high-voltage application, it is understood that an optocoupler may not be needed because electrical isolation would not be necessary.

When the input pulse 12 turns LED 22 ON, the LED 22 emits light 26 that turns DIAC 24 ON. When DIAC 24 is ON, current flows through current-limiting resistor 28 to a gate of a triode for alternating current (TRIAC) 30, and turns TRIAC 30 ON, commutating DIAC 24 OFF. Although a TRIAC 30 is shown in FIG. 1, it is understood that other solid-state switches, such as silicon-controlled rectifiers, MOSFETs, or IGBTs could also be used.

Before TRIAC 30 turns ON, a first capacitor 32 and a second capacitor 34 are charged in parallel through an inductive winding 36. Current flows from the input voltage 14, through a diode 38, and then passes from winding 36 to the first capacitor 32 and the second capacitor 34. The orientation of diode 38 prevents the winding 36 from discharging back into the input voltage 14. The first capacitor 32 and second capacitor 34 are charged at a first polarity, and the polarity of capacitor 32 is the opposite of the polarity of capacitor 34.

When TRIAC 30 turns ON, current flows in a counter-clockwise direction from the first capacitor 32 to the winding 36, and energy is stored in a magnetic field associated with the winding 36. A voltage across the capacitor 32 then drops to zero. The magnetic field associated with the winding 36 then collapses and current flows in a counter-clockwise direction back to the capacitor 32 by passing through diode 40 and then through TRIAC 30. At this point, TRIAC 30 commutates OFF. As shown in FIG. 1B, capacitor 32 is then charged at a second polarity that is opposite the first polarity. At this point, capacitors 32 and 34 have the same polarity and are operable to discharge in series to the output voltage 16. This “charge pump” process then repeats to continuously provide voltage to a load (not shown). When the input pulse is at an OFF position, the assembly 10 recharges, and when the input pulse is at an ON position, the assembly discharges as a “charge pump.” While FIG. 1a illustrates a high voltage direct current output, if a high voltage alternating current output is desired, an appropriate inverter could be used to perform such a conversion at an output of the converter assembly 10.

An inductive winding 42 is coupled in series to a resistor 44. Together winding 42 and resistor 44 provide a DC path to ground for charging capacitor 32, and also block any AC, which may be present from winding 36, from ground. A diode 40 is used to block current from flowing in a clockwise direction from TRIAC 30 to winding 36 and to prevent energy loss during the charge pumping process at slower rise-times. A capacitor 46 is coupled in series to a resistor 48. The capacitor 46 and resistor 48 are in parallel with TRIAC 30, and are used to increase noise immunity in order to avoid false triggering of TRIAC 30.

FIG. 2a illustrates a single stage of a second embodiment of a power converter assembly 50. Components 12, 14, 16, 18, 20, 22, 24, 26, 28, and 30 operate as described above. Also, as in the previous embodiment, the converter 50 increases the input voltage 14 to an output voltage 16 by a factor of 2×N, as shown in equation #1.

A first capacitor 52 and a second capacitor 54 are charged to an initial voltage at an initial polarity. When TRIAC 30 commutates ON, current flows in a clockwise direction from the first capacitor 52 through TRIAC 30 to an inductive winding 56, and energy is stored in a magnetic field associated with the winding 56. A voltage across the capacitor 52 then drops to zero and TRIAC 30 commutates OFF. The magnetic field associated with the winding 56 then collapses and current flows in a clockwise direction back to the capacitor 52, charging the capacitor 52 at an opposite polarity, as shown in FIG. 2b. At this point, capacitors 52 and 54 have the same polarity and are operable to discharge in series to the output voltage 16. Additional inductive windings 58 and 60 provide several functions: blocking AC energy from DC ground, blocking AC energy from input voltage 14, blocking fast rise time output voltage from DC ground, and providing fast charging of capacitors 52 and 54. A rise time is the time it takes for a voltage at an output of a converter assembly to peak for a single charge pump. Although windings 58 and 60 are electrically separate and shown as separate components, it is possible that they would be wound on the same magnetic core.

As shown in FIG. 2a, the assembly 50 uses windings 58 and 60 instead of the diodes 38 and 40 of assembly 10. The example windings 58 and 60 provide a maximum impedance to AC during discharge, and thus result in little loss of current to ground. In addition, when the assembly 50 is charging, the magnetic fields of windings 58 and 60 are opposing and cancel, thus providing a minimum inductance and a minimum impedance to a charging current. This facilitates a faster charging time for capacitors 52 and 54, and results in a faster rise time. In addition, because no diodes are utilized in the circuit of FIG. 2a, reversal of stage polarity is possible by reversing charge voltage polarity.

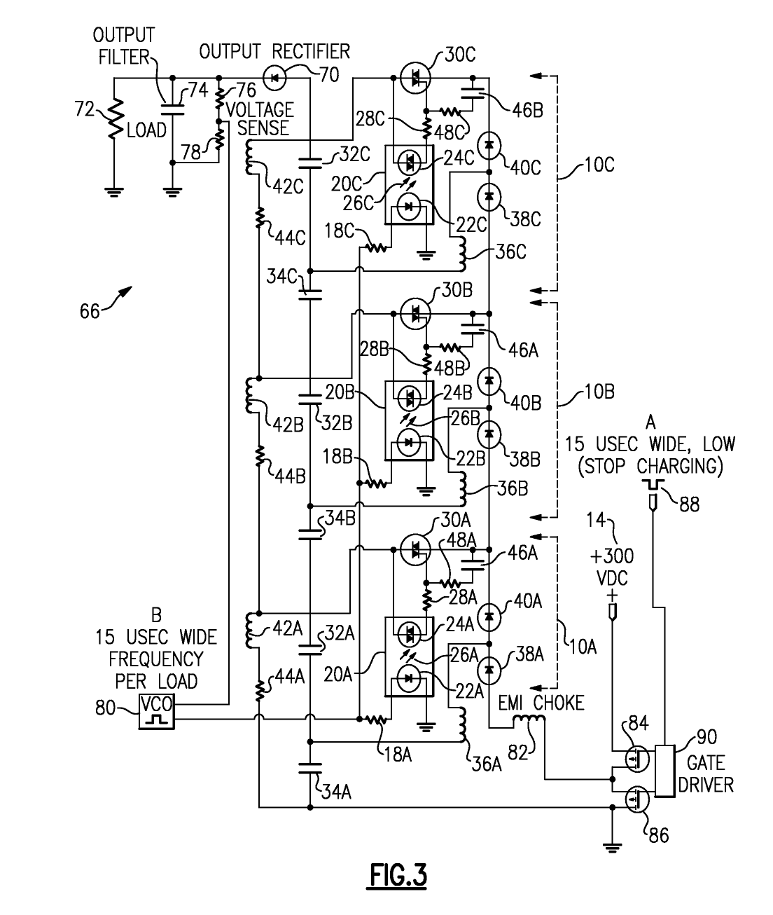

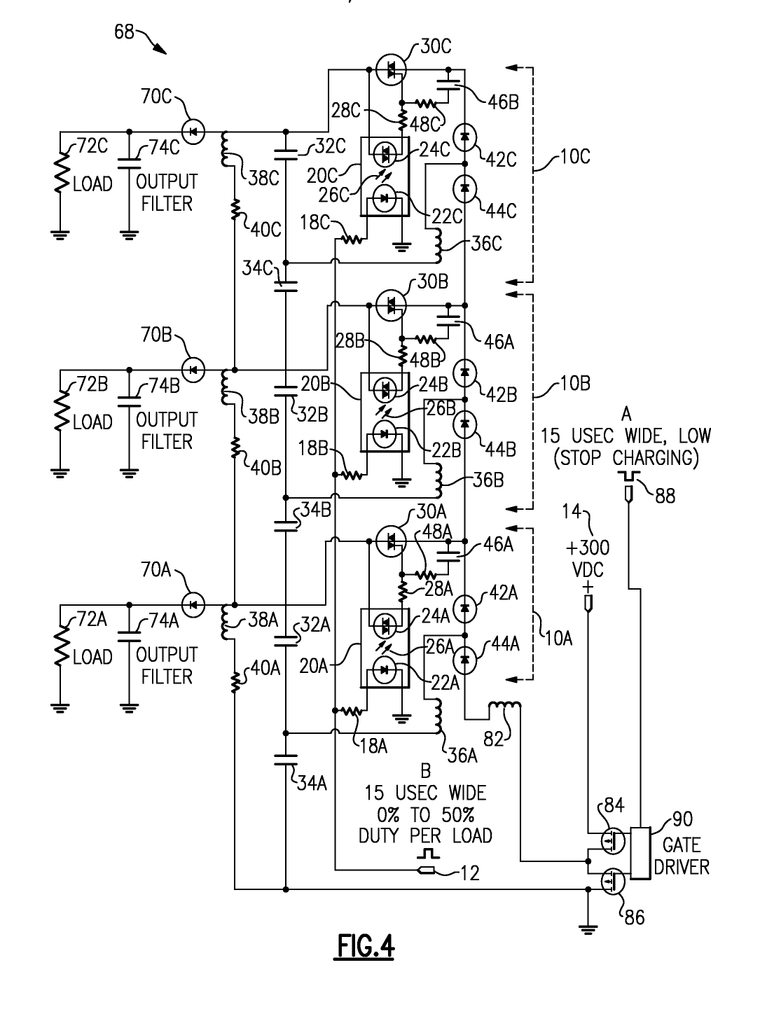

FIGS. 3 and 4 illustrate how the converter assembly 10 can be cascaded in order to provide a greater increase in voltage. As shown in FIG. 3, three converter stages 10a, 10b, and 10c are cascaded into a larger converter assembly 66, which provides an output voltage that is greater than the input voltage 14.

Using equation #1, since there are three assembly stages 10a, 10b, and 10c, “N”=3, and the output voltage would therefore be six times greater than the input voltage. Using the example values from FIG. 3, if the input voltage 14 is 300 volts, the output voltage would be 1,800 volts. In the assembly 66, current flows from capacitors 32a, 32b, 32c, 34a, 34b, and 34c to a diode 70. The diode 70 prevents current from discharging back into the individual converter assembly stages 10a, 10b, and 10c. From diode 70, current flows to a load 72 and to a capacitor 74. The capacitor 74 evens out the charge from each individual “charge pump” into a more continuous output.

Current also passes from diode 70 to voltage sense resistors 76 and 78 and then to a voltage controlled oscillator (VCO) 80 for feedback. VCO 80 provides a first input pulse to each converter stage 10a, 10b, and 10c, and also receives feedback from voltage sense resistors 76 and 78 in order to selectively alter the first input pulse in order to provide a desired output voltage. Choke 82 prevents switching noise from reaching the input voltage 14. MOSFETs 84 and 86 act as a half bridge and turn ON and OFF the input voltage 14 so that the capacitors 32a, 32b, 32c, 34a, 34b, and 34c are not simultaneously being charged and discharged. Second input pulse 88 activates gate driver 90 in order to turn MOSFETs 84 and 86 ON and OFF.

FIG. 4 illustrates a multiple output converter assembly 68. For clarity, a VCO is not shown in FIG. 4, although it is understood that a VCO could be included to perform a feedback regulation function. Assembly 68 outputs current to diode 70a after assembly stage 10a, to diode 70b after assembly stage 10b, and to diode 70c after assembly stage 10c. Using an example input voltage of 300 volts as shown in FIG. 4, this yields outputs of 600 volts, 1200 volts, and 1800 volts respectively.

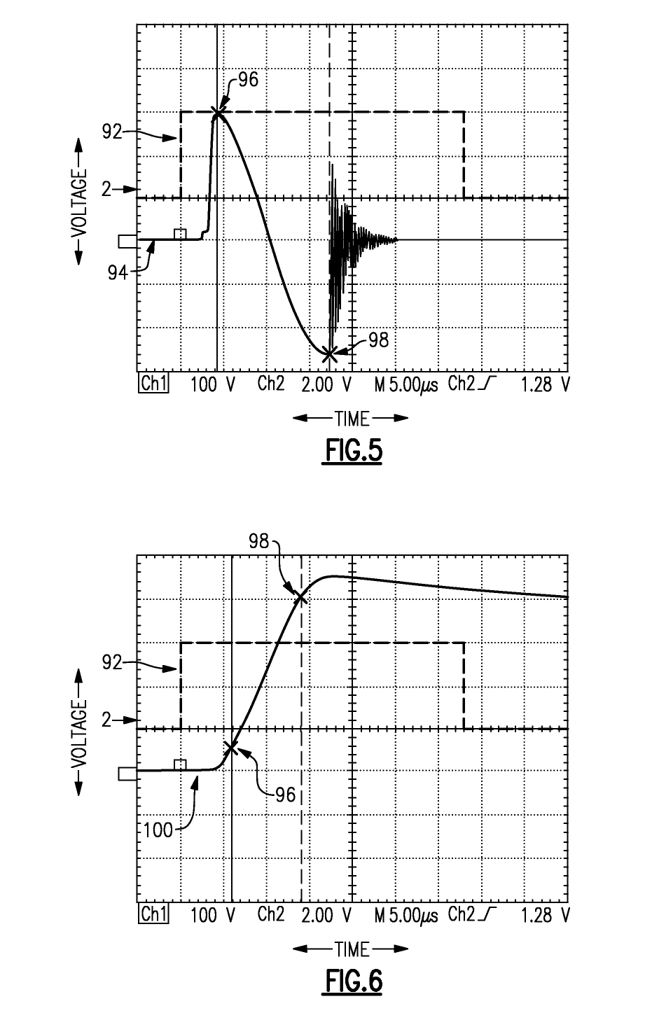

FIG. 5 is a graph that illustrates a voltage 94 across a 44 uH inductive winding as a function of time. An input pulse 92 is illustrated by a dotted line. The increase in the voltage 94 corresponds to the formation of a magnetic field associated with the winding, and the decrease in voltage 94 corresponds to the collapse of the magnetic field associated with the winding. The rise and fall of the voltage 94 all occurs within one phase of the input pulse 92. Using the magnitude of the output pulse as a scale, marker 96 corresponds to 10% of the output pulse and marker 98 indicates 90% of the output pulse. As the voltage across the winding decreases, the voltage at the output increases, as indicated by markers 96 and 98.

As described above, an inductive winding first builds up a magnetic field and a voltage across the winding increases, and then the magnetic field collapses and the voltage across the winding decreases. The duration of this process is a “charge reversal time.” A charge reversal can be calculated from the equation:

t=2π\sqrt{LC} equation #2

37 where “t” is the charge reversal time;

“L” is the inductance of a winding; and

“C” is the capacitance of a capacitor, or group of capacitors.

As shown in FIG. 5, equation #2 yields a charge reversal time of 13 microseconds.

A “rise time” is the time it takes for a voltage at an output of a converter assembly to peak for a single charge pump. The use of a solid state switch in a converter assembly facilitates rise times of less than 10 microseconds for an output voltage, and jitter less than 100 nanoseconds between pulses, even with simultaneous triggering of multiple stages. FIG. 6 illustrates a voltage 100 at an output of a converter assembly, using example values of a 0.47 uF capacitor and a 44 uH inductive winding. This yields a rise time of 8 microseconds. Notice that as in FIG. 5, the rise and fall of the voltage 100 occurs within one phase of the input pulse 92.

A charge pump energy balance can be calculated according to the equation:

(½)LI²−(½)CV² equation #3

where “L” is inductance;

“I” is current;

“C” is capacitance; and

“V” is a charging voltage

Equation #3 enables one to estimate peak current (“I”) from L, C, and V.

FIG. 7 illustrates that, as predicted by equation #2, using a smaller inductor can decrease a charge reversal time and can therefore decrease a corresponding rise time for a converter assembly. Using a 0.47 uF capacitor and a 12 uH inductive winding, an output voltage 102 raises from its 10% value to its 90% value 98 in 4.5 microseconds, as compared to the 8 microsecond rise time of FIG. 6.

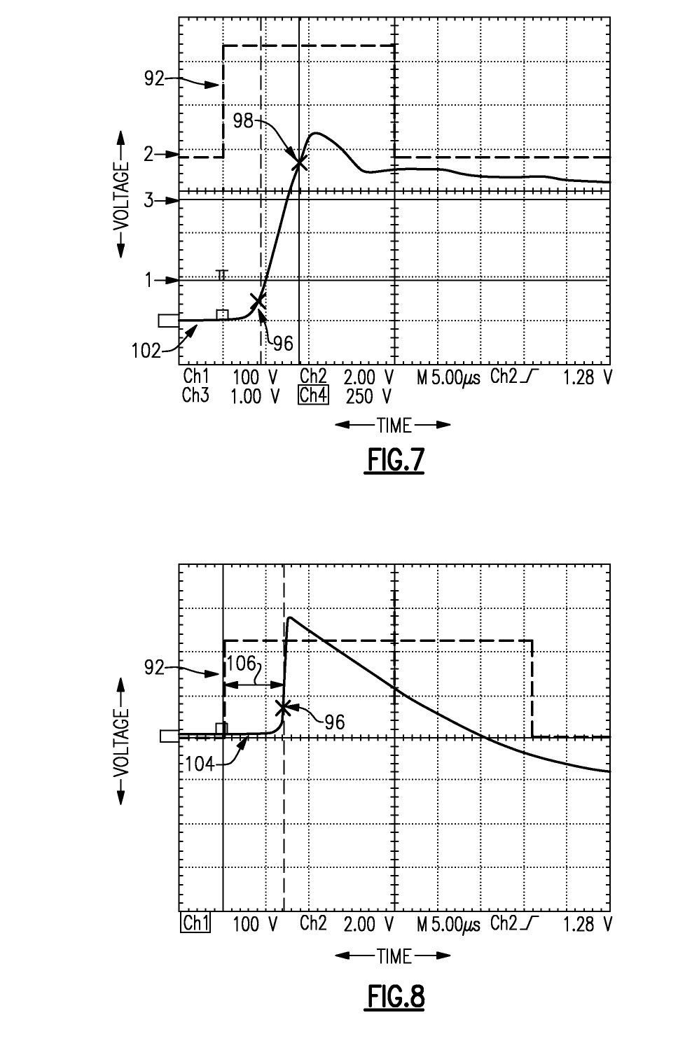

FIG. 8 illustrates a delay time of an example commercial TRIAC switch. From the increase in value of the input pulse 92 to the increase of an output voltage 104, there is a 2.8 microsecond delay 106. The cause of such a delay 106 can be attributed to upstream electronics.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A power converter assembly, comprising:
a first capacitor and a second capacitor, wherein the first capacitor and the second capacitor are operable to be charged in parallel to a first DC voltage and at a first polarity and to discharge in series at a second DC voltage that is greater than the first DC voltage; and
a switch coupled to the first capacitor operable to control the discharge of the first capacitor and the second capacitor.

2. The assembly of claim 1, comprising a plurality of sets of first and second capacitors coupled in series, wherein each of the first and second capacitors are individually charged in parallel, and wherein the plurality of sets of first and second capacitors are collectively discharged in series.

3. The assembly of claim 2, wherein the plurality of sets of first and second capacitors are collectively discharged into a single output.

4. The assembly of claim 2, wherein the plurality of sets of first and second capacitors are discharged into a plurality of outputs.

5. The assembly of claim 1, comprising a first winding coupled to the first capacitor, wherein the switch facilitates the discharge of the first capacitor and the second capacitor by selectively discharging the first capacitor into the first winding, and wherein the first winding returns energy to the first capacitor to charge the first capacitor at a second polarity opposite the first polarity so that the first capacitor and the second capacitor discharge in series.

6. The assembly of claim 5, comprising an input pulse, wherein the input pulse is coupled to the switch, and is operable to turn the switch ON and OFF.

7. The assembly of claim 6, comprising:
a light-emitting diode coupled to the input pulse; and
a trigger diode coupled to the switch, wherein the trigger diode activates the switch responsive to light from the light-emitting diode.

8. The assembly of claim 7, wherein the switch is a solid state switch.

9. The assembly of claim 8, wherein the trigger diode is a diode for alternating current and the switch is a triode for alternating current.

10. The assembly of claim 6, comprising:
at least one diode coupled to a first DC input voltage;
a second winding coupled to a first resistor, wherein the second winding is coupled to the first capacitor and the first resistor is coupled to the second capacitor; and
a third capacitor coupled to a second resistor, wherein the third capacitor and second resistor are coupled in parallel to the switch.

11. The assembly of claim 6, comprising:
a second winding coupled to the solid state switch and to the first and second capacitors; and
a third winding coupled to the first winding and to the first capacitor.

12. A method of converting an input voltage to an increased output voltage, comprising the steps of:
a) charging a first capacitor and a second capacitor in parallel to a first voltage and at a first polarity; and
b) discharging the first and second capacitor in series at a second voltage that is greater than the first voltage.

13. The method of claim 12, wherein the step of discharging includes:
discharging the first capacitor into an inductor to form a magnetic field associated with the inductor, collapsing the magnetic field associated with the inductor to charge the first capacitor at a second polarity opposite the first polarity, and selectively discharging the first capacitor and the second capacitor in series at a second voltage.

14. The method of claim 12, wherein step a) comprises individually charging a plurality of sets of first capacitors and second capacitors in parallel, and wherein step b) comprises collectively discharging the plurality of sets of first capacitors and second capacitors in series.

15. The method of claim 14, wherein the plurality of sets of first and second capacitors are discharged into a single output.

16. The method of claim 14, wherein the plurality of sets of first and second capacitors are discharged into a plurality of outputs.
